(19) United States
(12) Patent Application Publication
(10) Pub. No.: US 2011/0199025 A1
(43) Pub. Date: Aug. 18, 2011

(54) LIGHT ASSEMBLY FOR INFORMATION DISPLAY

(75) Inventor: Roy W. Martin, Anacortes, WA (US)

(73) Assignee: Biz Research, Inc., Anacortes, WA (US)

(21) Appl. No.: 12/705,124

(22) Filed: Feb. 12, 2010

(51) Int. Cl. H05B 37/02; F21S 4/00

(52) U.S. Cl. 315/360; 362/249.02

(57) ABSTRACT

The auxiliary lighting system includes a pair of light assemblies, attached to or integral with opposing sides of an informational display. The light assemblies produce light of approximately 300 lux at 50 cm. Each light assembly includes a plurality of individual light sources, such as LEDs, distributed so that the light therefrom does not to irritate the eyes of the user, with approximately 2 lumens being produced from each 5 mm by 5 mm region of the light assemblies.

### TECHNICAL FIELD

This invention relates generally to auxiliary light systems for maintaining wakefulness for individual users.

### BACKGROUND OF THE INVENTION

It has been well documented that drowsiness, loss of attention, drop in cognitive performance or failure to rapidly respond to occurring events are indicative of mental fatigue, sleep deprivation, or simply boredom, as well as other causes. Microsleep is a new term which has been applied to short lapses in attention or occurrence of actual short sleep events. These sleep events may last from a fraction of a second to one-half minute or more. Incidents of drowsiness or especially microsleep can be dangerous and are frequently cited as a cause of serious accidents involving automobiles, trains, ships and other vehicles.

Some attempts have been made, particularly on highways, to alert drivers from wandering from their driving lanes. This typically involves mechanical elements such as a series of bumps or grooves which are placed along or integrated into the highway lanes. While sleep deprivation is a factor in drowsiness and/or micro sleep, other factors are important as well, including late night shift work, rapid crossing of multiple time zones, and certain types of medications.

Further, it is also well accepted that there is a normal sleep and wake cycle for humans, known as the circadian rhythm, which is synchronized to the time of first light of a normal day and the time of darkness of night. If the circadian rhythm is disrupted or altered in some way, drowsiness and microsleep can result.

It is also known that short-time exposure to bright light can have an effect of temporarily suppressing or delaying the tendency toward drowsiness or microsleep. Bright lights are thus in effect used to affect the circadian rhythm. One patent, U.S. Pat. No. 6,350,275, is directed toward specialized glasses which have LEDs to produce a desired level of light. Another patent, U.S. Pat. No. 6,875,225 to Pederson et al, teaches a small portable panel for the purpose of light therapy. Heretofore, however, an appropriate structure or system for a practical light exposure system in a normal work context, particularly involving informational display devices, such as a common computer monitor screen, has not been developed. There is hence no existing structural bridge between light therapy general knowledge and practical devices for applying that knowledge to conventional work environments.

Accordingly, it is desirable and an object herein to provide a practical system for providing an auxiliary light assembly adapted specifically for use with an information display and configured and arranged to maintain the human user of the display in a “waking up” condition.

### DISCLOSURE OF THE INVENTION

Accordingly, an auxiliary lighting system for an informational display disclosed herein, comprises: a pair of light assemblies, positioned on opposing sides of the informational display, wherein the light assemblies are brighter than the display and produce light at a level in the range of 150-350 lux at approximately 50 cm. from the screen, the light being distributed so as not to irritate the eyes; and wherein the system includes an assembly for attaching the light assemblies, respectively, to the opposing sides of the informational display or wherein the light assemblies are an integral part of the informational display.

### BRIEF DESCRIPTION OF THE DRAWINGS

FIG. 1 is a perspective view of one embodiment of the light assembly disclosed herein with an information display.

FIG. 2 is an exploded view of one side portion of the light assembly of FIG. 1.

FIG. 3 is a perspective view of another embodiment of the light assembly of FIG. 1.

FIG. 4 is a block diagram for the control circuit of the light assembly.

FIGS. 5 and 5A are cross-sectional and perspective views, respectively, of an attachment mechanism for the light assembly of FIG. 1 to a computer monitor screen.

FIGS. 6 and 6A are elevational and perspective views of another embodiment of an attachment mechanism for the light assembly of FIG. 1.

FIG. 7 is a perspective view of the attachment mechanism of FIGS. 6 and 6A in a partially folded configuration.

### BEST MODE FOR CARRYING OUT THE INVENTION

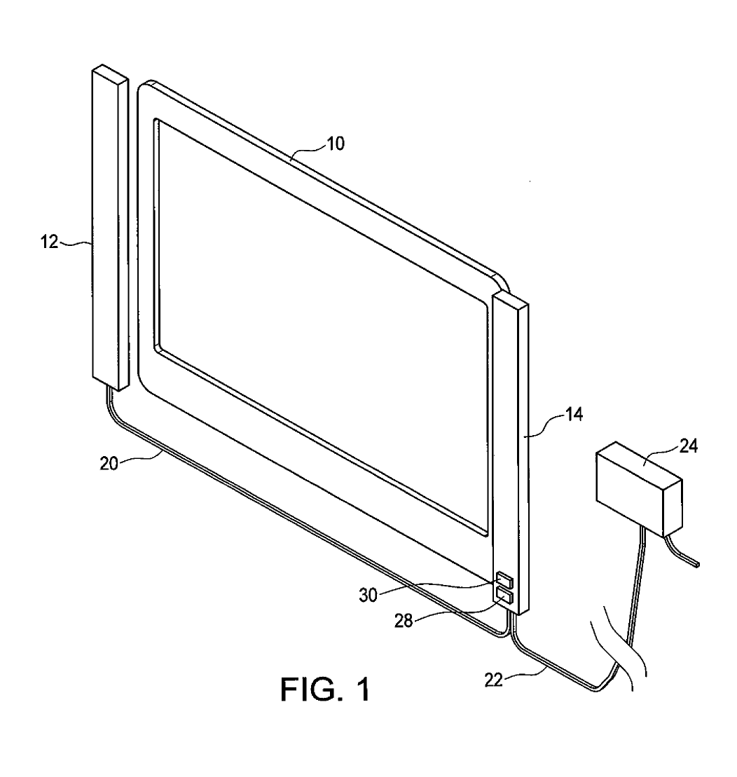

As discussed above, a tendency toward drowsiness, lack of attention or microsleep is particularly noticeable at certain times, such as when a user is positioned for long intervals before what is generally referred to herein as an information display, such as a computer monitor. In today's working world, with a large and increasing number of people sitting for long periods of time before such a display, the necessity for maintaining a consistent degree of wakefulness is important to maintain productivity and/or safety in those environments/duties. FIG. 1 shows an electronic display screen, such as a computer monitor, at 10. Two adjacent auxiliary light assemblies 12 and 14 are positioned adjacent to opposing sides 16 and 18 of the display screen. The display screen 10 is intended to be broadly applicable, to include a computer screen, a radar/sonar screen, global positioning display or other graphic or video display. The light assemblies 12 and 14 are electrically interconnected by a cable 20 and in turn are connected by an additional cable 22 to a control module 24. The module 24 converts electric power from a typical source such as the wall, e.g. 120V, 60 Hz, to the value appropriate for the light assemblies. In the embodiment shown, there are two control switches. One control switch 28 activates the light assemblies, which stay on thereafter for a pre-set time under the control of the control module. A typical time could be 15 minutes, but this could be varied, as discussed in more detail below. Another actuation of control switch 28 results in the side lights being immediately extinguished.

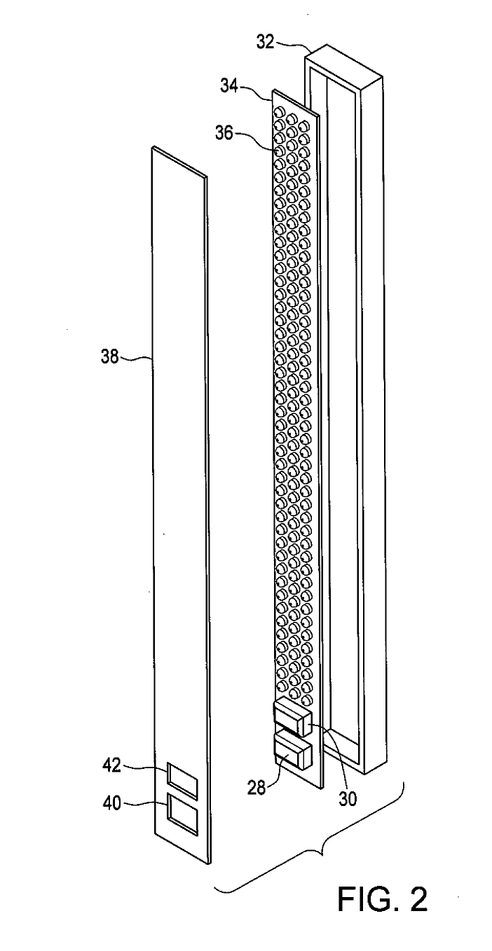

A second control 30 initiates a timing sequence for the light assemblies. For example, a preferred sequence includes a delay of 1 hour and 15 minutes, following which the lights come on for 15 minutes. This arrangement can be timed, for instance, relative to a particular shift of an operator. It should be understood, however, that other timing sequences can be used, and selected, again as discussed in more detail below. FIG. 2 shows details of one of the light assemblies, for instance, light assembly 14. Each light assembly includes a housing 32, a printed circuit board 34 with an array of LED lights 36, control switches 28 and 30 and a light diffusing cover 38 with openings 40 and 42 for the control switches. The light assembly 12 is similar to light assembly 14, except without the control switches. In general, the light assemblies extend for the full height of the monitor, and are sufficiently wide to provide the required amount of light. This arrangement can be varied, for instance, the light assemblies need not necessarily be the full height of the monitor. In general, for one embodiment, the number of LED lights is 180, comprising three adjacent columns of lights, with each column containing 30 LEDs. The LEDs must provide a total amount of light sufficient to produce a bright light at a level of approximately in the range of 150-350 lux at a distance of 50 cm in front of the screen, with approximately 300 lux being preferred. Also, the light level can be adjustable by a separate control, to accommodate individual users. The individual LED light sources must be distributed or positioned in such a manner within each light assembly that each 5 mm×5 mm region of the light assembly produces preferably only 2 lumens or within a range of approximately 1.5-2.5 lumens. This arrangement is important so that when the user looks directly at the light assembly, they will not irritate his/her eyes.

The distribution (relative position within the array) of the light sources is important. The light must be bright enough to produce a waking effect in a human user of the monitor, but the distribution of the individual light sources must be such that the user can look directly at the light sources without irritation to their eyes.

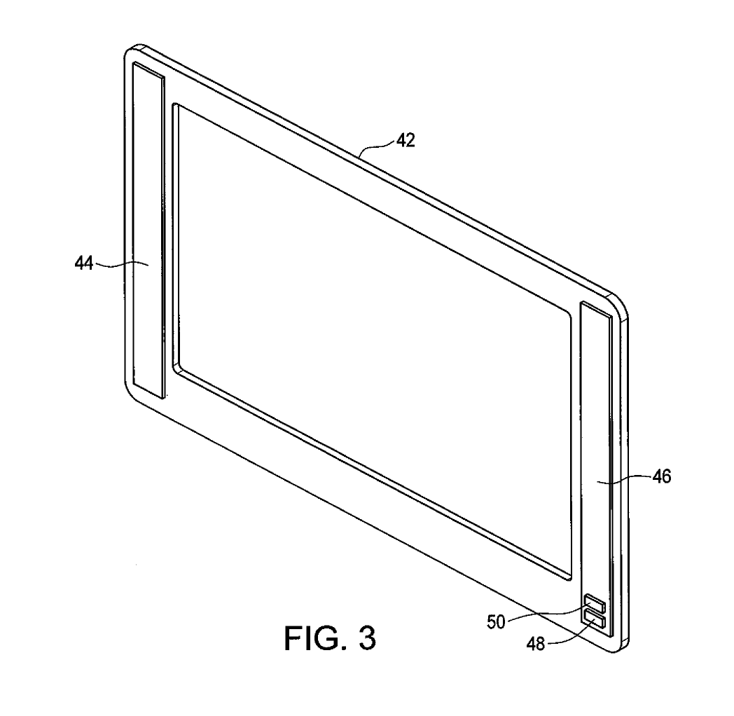

FIG. 3 shows an alternative embodiment in which a monitor screen 42 includes auxiliary light assemblies 44 and 46 which are built into the monitor itself. Light assemblies 44 and 46 have the same characteristics as described above with respect to FIGS. 1 and 2, including control switches 48 and 50. The brightness of the light can be adjusted by a separate control, like with the embodiment of FIG. 1. While it is recognized that the monitor 42 itself produces light, it is important that the light produced by the light assemblies be several orders of magnitude above the light level of the monitor, like that for the embodiment of FIG. 1.

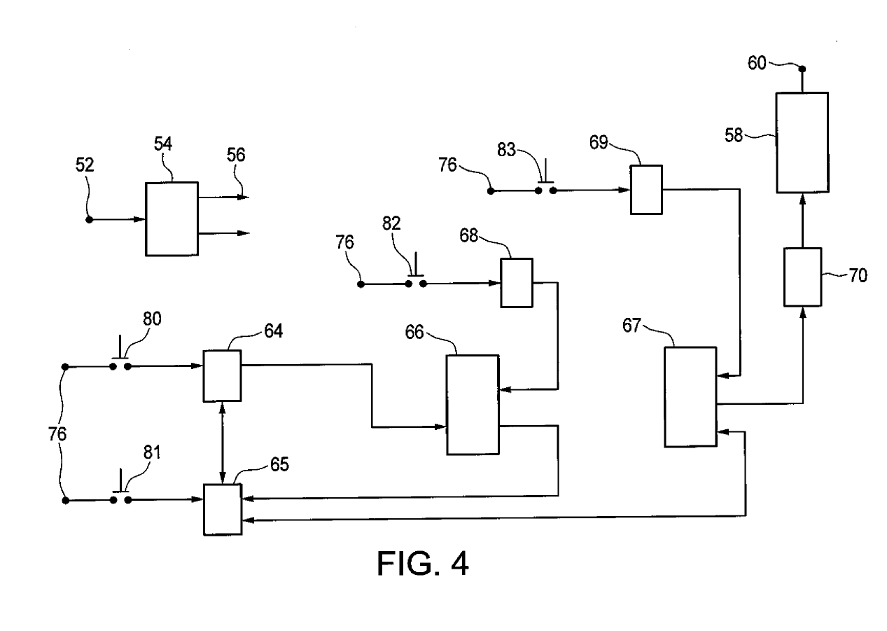

FIG. 4 is a block diagram of the control circuitry for the light assemblies, represented at 24 in FIG. 1. A power source such as power from the wall is represented at 52. This can be provided for instance, through a conventional electrical cable, 115 Vrms at 60 Hz. A power converter 54 converts the power from the wall and provides it in proper form (voltage/current levels) for the control circuit signal 56. The electrical signal 56 is provided to two LED arrays represented at block 58 through input connection represented at 60. The control circuit signal 56 is also provided to various logic circuits 64-70, the operation of which is explained in more detail below. In addition, the signal at output 56 is provided at several circuit points identified at 76 to operate four switches 80-83.

The logic circuits include two “one shot” circuits 66 and 67. The one-shot circuit 67 produces a short preset “on-time” when control switch 28 is operated to turn the light assemblies on. Switch 81 in FIG. 4 corresponds to switch 28 in FIG. 1. The preferred short on-time is 15 minutes, which can be varied by actuating switch 83, which results in logic circuit 69 advancing through a selection of preset times, for example, 10, 20 or 30 minutes, in addition to 15 minutes. Other times can be programmed in the selection if desired. Once the one-shot circuit 67 is activated, it transmits a signal to the LED driver circuit 70. Driver Circuit 70 applies the proper control signals to the LEDs in the light assemblies, represented at 58 in FIG. 4 and referred to at 36 in FIG. 2. Drive circuit 70 is adjustable to allow the current to the LEDs to be varied, which in response results in the brightness level being at a desired level for the user.

A second one-shot circuit 66 produces a repetitive lighting sequence comprising an initial time delay followed by a set “on” time for the LEDs in the light assemblies, in response to actuation of control switch 30. Switch 80 in FIG. 4 corresponds to control switch 30 in FIG. 1. The initial time delay of the one-shot circuit 66 can be selected by actuating switch 82, which activates selection logic circuit 68, which in turn advances through a selection of preset times such as for instance, 45, 60 or 75 minutes, or other programmed times. The “on-time” of the LED lights following the delay in this mode is controlled by one shot 67 and logic circuit 69.

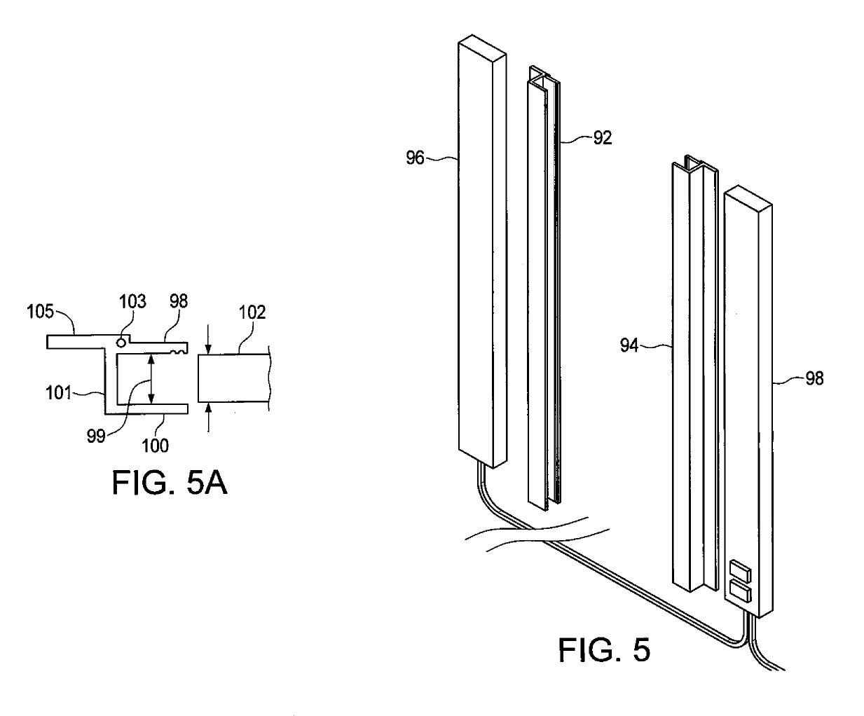

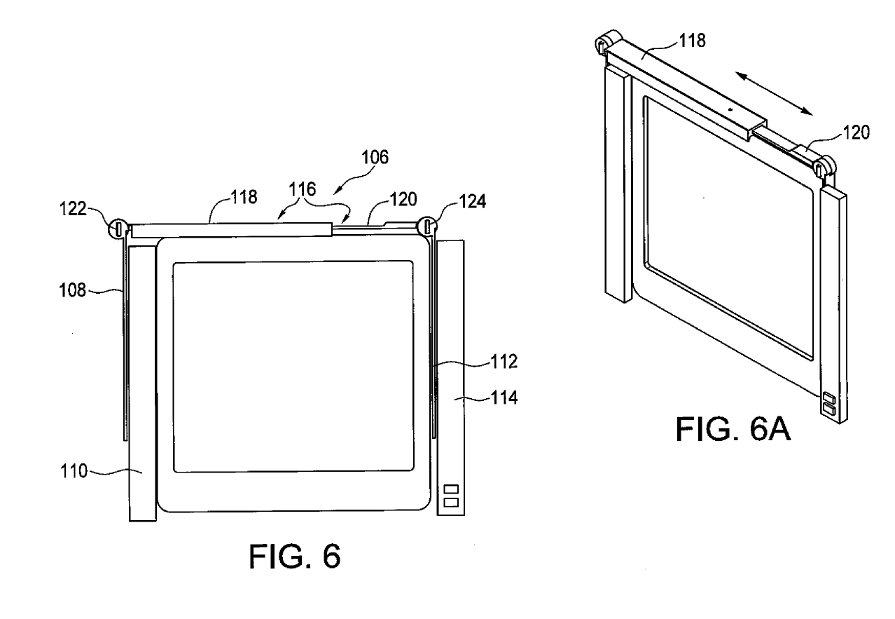

FIGS. 5 and 5A, as well as FIGS. 6 and 6A, illustrate different arrangements for attaching the light assemblies 12 and 14 to the display screen. FIGS. 5 and 5A show clamping members 92 and 94 which respectively receive light assemblies 96 and 98, attached thereto in a variety of ways, such as by adhesive or mechanical fasteners, e.g. screws, or even by molding the light assemblies to the clamps. Each clamping member includes a portion having two parallel arms 98 and 100 and an intermediate joining portion 101, the parallel arms being slightly flexible so that the arms apply pressure against the edge of the display screen 102, tending to hold the clamping member and hence the light assembly attached thereto in position relative to the display screen. The distance 99 between the inside surfaces of arms 98 and 100 is less than the thickness of the display screen, which assists in the clamping action. An opening 103 can be included in the clamping member as shown which aids in the flexibility of arm 98. The clamping assembly includes an arm 105, parallel to, actually close to registry with, and extending from, arm 98, which is perpendicular to joining portion 101, thereby defining two surfaces at approximately 90° to each other, against which a light assembly can be positioned and attached by various means, including an adhesive, or various fastening elements such as screws, etc. It should be understood that the clamping members can be manufactured in different sizes and shapes to accommodate the different information display screens.

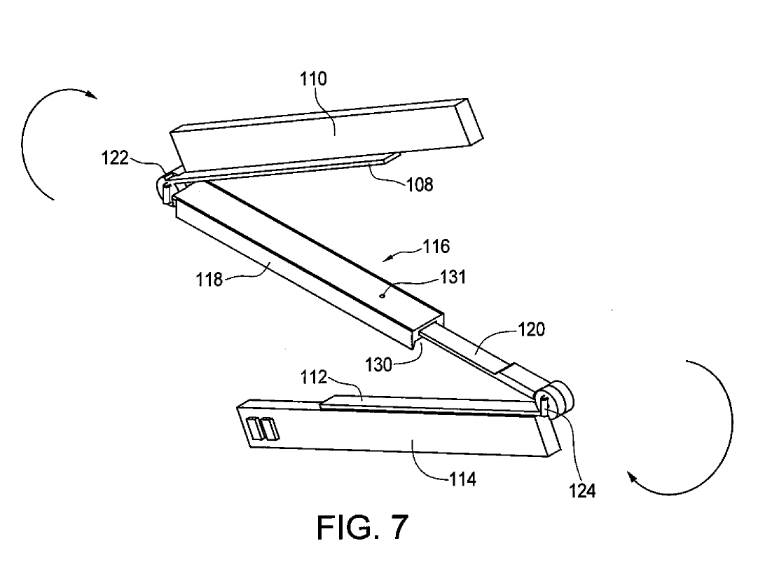

FIGS. 6, 6A and 7 show another embodiment for attaching the light assemblies to the display/monitor. This embodiment is directed toward a draping assembly, referred to generally at 106, which includes a left holding bracket 108 for holding one light assembly 110 and a right holding bracket 112 for holding the opposing light assembly 114. The light assemblies are connected to the holding brackets by various means, including an adhesive or various fasteners such as screws or other attachment mechanisms. The two holding brackets 108 and 112 are connected by a central telescoping connecting assembly 116. The connecting assembly 116 includes outer and inner telescoping elements 118 and 120, with telescoping element 120 moving into and out of telescoping element 118, and thumbscrews 122 and 124.

Thumbscrew 122 rotatably connects holding bracket 108 to outer telescoping element 118, while thumbscrew 124 rotatably connects holding bracket 112 to inner telescoping element 120. Thumbscrews 122 and 124 lock draping assembly 106 into a particular position, such as shown in FIGS. 6 and 6A about a screen/monitor 126. Thumbscrews 122 and 124 are arranged so that the respective holding brackets 108 and 112 swivel relative to their telescoping elements 118 and 120. Inner telescoping element 120 is capable of moving in and out of outer telescoping element 118, providing a capability of increasing the distance between the two holding brackets 108 and 112 so that the draping arrangement 106 can accommodate various size screens.

FIG. 7 shows the draping arrangement in a partially folded configuration, wherein holding bracket 108 with its light assembly 110 is rotated partially clockwise about thumbscrew 122, while holding bracket 112 with its light assembly 114 is rotated partially about thumbscrew 124, also in a clockwise rotation. The holding brackets could be folded further than shown, coming against telescoping connecting assembly 116. FIG. 7 also shows the lower edge 130 of outer telescoping element 118 beveled, so that it can rest conveniently on the top of the display screen/monitor, as well as a threaded opening 131, which permits the telescoping elements to be locked in a desired position, with the use of a machine screw.

Accordingly, a light assembly has been described which is structured so as to conveniently provide auxiliary lighting for an informational display such as a monitor, to maintain wakefulness of the user during use of the display. The information display could be for various purposes as noted above. It could also be an ebook reading device. The light assembly for such a device would be matched to the size of the device.

Although a preferred embodiment of the invention has been disclosed for purposes of illustration, it should be understood that various changes, modifications and substitutions may be incorporated in the embodiment without departing from the spirit of the invention, which is defined by the claims which follow.

What is claimed is:

1. An auxiliary lighting system for an informational display, comprising:
a pair of light assemblies, positioned on opposing sides of the informational display, wherein the light assemblies are brighter than the display and produce light at a level in the range of 150-350 lux at approximately 50 cm. from the screen, the light being distributed so as not to irritate the eyes; and
wherein the system includes an assembly for attaching the light assemblies, respectively, to the opposing sides of the informational display or wherein the light assemblies are an integral part of the informational display.

2. The auxiliary light system of claim 1, wherein the light is approximately 300 lux.

3. The auxiliary lighting system of claim 1, wherein the light assemblies produce light at a level which is several orders of magnitude higher than the light from the display.

4. The auxiliary lighting system of claim 1, wherein the light level is adjustable.

5. The auxiliary lighting system of claim 1, including a control system for turning the light assemblies off after a preselected time following actuation of the light assemblies.

6. The auxiliary lighting system of claim 5, wherein the control system automatically actuates the light assemblies at preselected intervals.

7. The auxiliary lighting system of claim 4, wherein the control system is programmable by a user to determine the time interval during which the light assemblies are on following actuation thereof and/or the successive times when the light assemblies are automatically actuated.

8. The auxiliary lighting system of claim 1, wherein the light assemblies comprise a plurality of LEDs, wherein the LEDs are distributed so that each 5 mm×5 mm region produces approximately 2 lumens.

9. The auxiliary lighting system of claim 1, wherein the light assemblies are attached to the sides of the information display by adhesive, Velcro® or mechanical fastening elements.

10. The auxiliary lighting system of claim 1, wherein the attaching assemblies include a mounting member which is attachable to the sides of the information display, and wherein the light assemblies are attached to the mounting member.

11. The auxiliary lighting system of claim 1, wherein the attaching assembly is a draping assembly which includes two spaced holding members to which the lighting assemblies are attached and a telescoping component connected to and intermediate of the two holding members, the holding members being connected to opposing ends of the telescoping component by swivel connecting elements.
